(19) United States
(12) Patent Application Publication
(10) Pub. No.: US 2018/0342132 A1
(43) Pub. Date: Nov. 29, 2018

(54) METHODS, DEVICES AND SYSTEMS FOR PLAYING A ZERO-SUM GAME

(71) Applicant: Neal J. Hyams, Gardena, CA (US)

(72) Inventor: Neal J. Hyams, Gardena, CA (US)

(21) Appl. No.: 15/985,587

(22) Filed: May 21, 2018

Related U.S. Application Data
(60) Provisional application No. 62/510,161, filed on May 23, 2017.

(51) Int. Cl. G07F 17/32; A63F 13/50; A63F 13/80

(52) U.S. Cl. CPC G07F 17/3272; A63F 13/80; A63F 13/50

(57) ABSTRACT

Systems, devices and methods are provided for a zero-sum game for determining a single-winner outcome between a predetermined number of players ranging from two to eight players. In some embodiments, the zero-sum game includes a pair of random number generators, a plurality of endgame tokens, currency tokens, insurance tokens, and a non-standard deck of twenty-four action cards.

### CROSS-REFERENCE TO RELATED APPLICATIONS

The present application claims priority to and the benefit of U.S. Provisional Patent Application Ser. No. 62/081,851, filed Nov. 19, 2014, which is incorporated by reference herein in its entirety for all purposes.

### FIELD

The subject matter described herein relates generally to a zero-sum game for determining a single-winner outcome where there is a predetermined number of players. More specifically, the subject matter includes a fast-paced game to be played by two to eight players, in which the game includes a pair of random number generators, a plurality of endgame tokens, currency tokens, insurance tokens, and a non-standard deck of twenty-four (24) action cards.

### BACKGROUND

It is well-known that traditional card games and board games can provide a great source of entertainment and social interaction for their players. However, recent scientific studies have shown that games can also confer a number of other important benefits to people of all ages. For example, according to one study by researchers at Carnegie Mellon University and the University of Maryland, playing games can improve the numerical understanding and counting skills of pre-school-aged children. Similarly, according to a 2003 article published in the New England Journal of Medicine, researchers have discovered that playing games can reduce the risk of cognitive decline, depression and dementia in the elderly. Other examples of benefits from playing games are abundant in the scientific literature.

Despite these benefits, however, the popularity of traditional card games and board games is waning. One recent survey in the U.K. reported that only half as many children aged 7-14 today play chess compared to their parents when they were growing up (24% vs. 45%), and far fewer children play card games than their parents did (44% vs. 73%). This declining trend can be attributed to various reasons. First, certain games take too long to play and thus are not a convenient source of entertainment in a face-paced world. Second, some games are physically cumbersome and require a large number of game pieces, a game board or a significant amount of playing space. This also makes it difficult for players to transport the game between different locations. Third, some card games and board games include a myriad of esoteric and complex rules, making it difficult for new players to join. Fourth, some games are purposely designed for a limited number of players (e.g., one-on-one games like Connect Four) and/or a specific age range (e.g., for young children or mature adults), and thus are not adaptable to different situations in which the size or composition of a party may vary.

For these and other reasons, a need exist for a fast-paced, easy-to-learn and easily portable game that can accommodate a varying number of players of all ages.

### SUMMARY

A number of embodiments of systems, devices and methods are provided herein for a fast-paced, easy-to-learn and easily portable zero-sum game that can be played by a predetermined number of individuals, ranging from two to eight players. In some embodiments, the zero-sum game can comprise a finite number of endgame tokens, a first random number generator, a second random number generator, a plurality of currency tokens, a plurality of insurance tokens, and a non-standard deck of twenty-four (24) action cards. The object of the zero-sum game is simple—to obtain a majority of endgame tokens from a community bank area. A winner is determined when no endgame tokens remain in the community bank area.

In the described embodiments, players take turns, one at a time, during which an active player can either generate a pair of random numbers with the random number generators or, optionally, play an action card in his or her possession. Depending on the outcome of the random number generation, the player can either experience beneficial outcomes, e.g., receiving an opportunity to exchange a currency token for an endgame token from the community bank area, or otherwise suffer detrimental outcomes, e.g., surrendering one or more currency tokens to the community bank area. Furthermore, in certain situations described herein, a player can strategically play an action card either to his or her benefit, or to another player's detriment.

In this manner, the example embodiments of a zero-sum game disclosed herein reflect a unique combination of quick and exciting gameplay, a dynamic mixture of strategy and luck, as well as a set of rules that is easy to learn for individuals of all ages.

Moreover, as further described herein, variations of the game can be employed for additional challenges. For example, in certain embodiments where there are four players, teams can be established, where each player receives two (2) currency tokens, one (1) insurance token, and eleven (11) endgame tokens are placed in the community bank area. Endgame tokens are subsequently maintained by one designated player on each team. As another example of a variation, one endgame token can be assigned a higher value (2×, 3×, etc.) relative to the other endgame tokens, with all endgame tokens placed in a blind pouch. During the game, and at an appropriate time, a player can withdraw an endgame token from the blind pouch without knowing its value until a visual identification is made. Other variations, combinations and permutations are described herein, and are fully within the scope of the present disclosure.

Other systems, devices, methods, features and advantages of the subject matter described herein will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a pictorial diagram depicting components of an example embodiment of a zero-sum game.

FIG. 2 is a pictorial diagram depicting a starting arrangement for an example embodiment of a zero-sum game where there are two players.

FIG. 3 is a pictorial diagram depicting a starting arrangement for an example embodiment of a zero-sum game where there are three players.

FIG. 4 is a pictorial diagram depicting a starting arrangement for an example embodiment of a zero-sum game where there are four players.

FIG. 5 is a flow diagram depicting the steps comprising a turn in an example embodiment of a zero-sum game.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a”, “an”, and “the” include plural referents unless the context clearly dictates otherwise.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

Generally, embodiments of the present disclosure comprise systems, devices, and methods for playing a zero-sum game and for determining a single game winner from a predetermined number of players, ranging from one to eight players. In some embodiments, the zero-sum game can include, at least, the following physical components: a finite and predetermined number of endgame tokens, a first random number generator, a second random number generator, a plurality of currency tokens, a plurality of insurance tokens, and a non-standard deck of twenty-four (24) action cards. It should be further noted that the embodiments disclosed herein include systems and methods which can be implemented as programmatic instructions stored in the memory of one or more electronic devices, where the electronic devices can include a power source, communication circuitry, transmitters, receivers, processors and/or controllers (e.g., for executing instructions), which can perform any and all method steps, or facilitate the execution of any and all method steps described herein. These embodiments can be used, and can be capable of use, to implement those steps performed by their aforementioned physical component counterparts for any and all of the methods described herein. Such electronic devices can include personal computers (“PCs”), game consoles, mobile communications devices (e.g., smart phones), tablet computing devices, laptops, or any other portable computing device having a memory for storing instructions, one or more processors, a user input device and a visual display. Further, those of skill in the art will recognize that the electronic versions of the embodiments disclosed herein can be played by multiple players over a local area network, a wide area network, a wireless local area network, or a cellular network regardless of geographical location by using any of the aforementioned electronic devices in accordance with standard networking protocols.

As mentioned, a number of embodiments of systems, devices, and methods are described herein that provide for a unique zero-sum game for determining a single game-winner from a predetermined number of players. These embodiments allow for a fast-paced, easy-to-learn and easy-to-transport game, that can be played by individuals of any age, and which can easily be adapted to any number of players, between two and eight players. Before describing specific rules and aspects of the embodiments in detail, however, it is first desirable to describe the individual components that are included in the zero-sum game, as well as examples of their operation, all of which can be used with the embodiments described herein.

### Example Embodiments of Zero-Sum Game Components

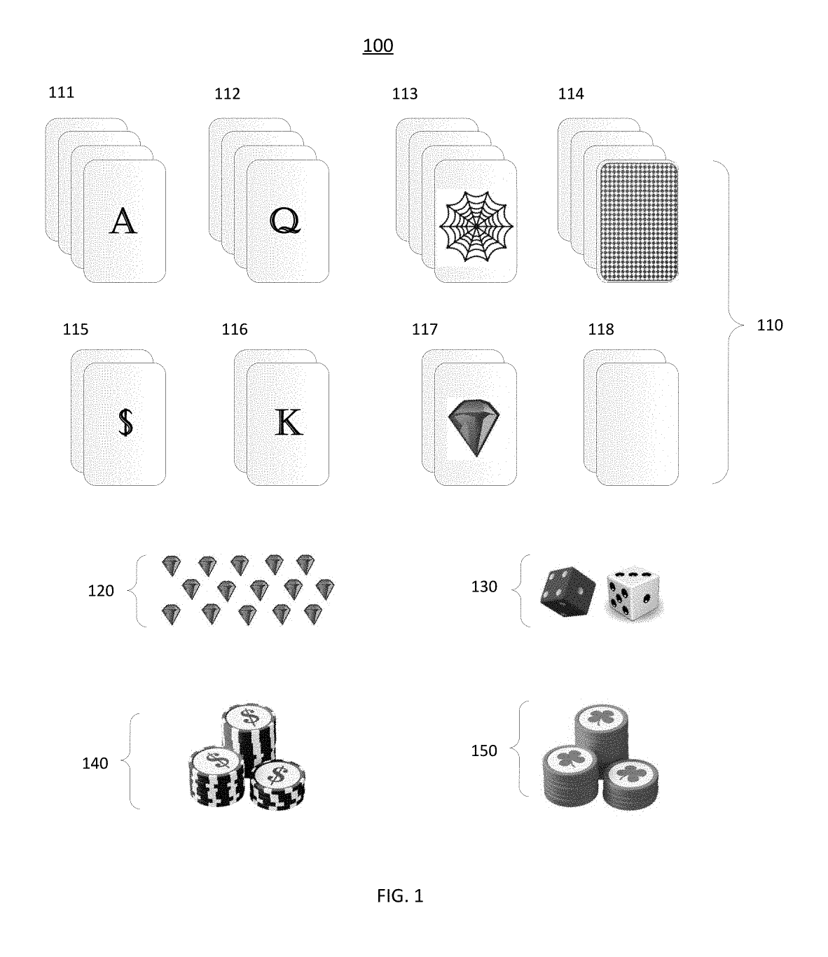

FIG. 1 is a pictorial diagram depicting the various components of one example embodiment of a zero-sum game 100. In most embodiments, zero-sum game 100 can include a non-standard deck of twenty-four (24) action cards 110, a plurality of endgame tokens 120, a pair of random number generators 130, a plurality of currency tokens 140 and a plurality of insurance tokens 150. The components of game 100 can be bundled together as a kit, or, alternatively, can be provided separately as individual and/or replacement components.

According to one aspect of the disclosed embodiments, the zero-sum game 100 includes a plurality of endgame tokens 120, which can consist of a finite number of jewels or jewel-shaped tokens. As depicted in FIG. 1, game 100 can include fifteen (15) endgame tokens 120. However, as described in further detail below, a subset of endgame tokens can be used during the game, depending on the number of players and/or the desired length of the game. For example, in a two-player game, seven (7) endgame tokens can be used instead of all fifteen (15) jewels. Similarly, in a three-player game, eleven (11) jewels can be used; in a four-player game, thirteen (13) jewels can be used; and in a five-, six- or seven-player game, either thirteen (13) or all fifteen (15) jewels can be used. Furthermore, in some embodiments, a custom logo (e.g., for a sports team or university) can be emblazoned on each endgame token 120 as desired. In other embodiments, as described earlier, one or more endgame tokens 120 can be assigned a greater value relative to other endgame tokens 120. For example, a visually distinctive “gold” jewel can be assigned a value that is twice the value of the other jewels 120. During gameplay, the endgame tokens 120 can be placed in a blind pouch (not shown), and players can withdraw each endgame token 120 during the game, as appropriate, without knowing the respective value of the endgame token until a visual identification is made.

According to another aspect of the disclosed subject matter, zero-sum game 100 can also include currency tokens 140 and insurance tokens 150, sometimes also referred to, respectively, as “money chips” and “insurance chips.” A predetermined number of currency tokens 140, or “money chips,” are distributed to each player at the beginning of the game. In some embodiments, for example, each player can receive two currency tokens 140 at the beginning of the game, each of which can later be exchanged for either an endgame token or an action card during gameplay. In addition, in some embodiments, each player can receive two currency tokens 140 to be held “in reserve.” Reserve currency tokens cannot be exchanged for endgame tokens or actions cards, but are instead surrendered to the community bank area when a player is subject to a penalty, e.g., rolling “craps” (double ones or sixes). In some embodiments of the zero-sum game, for simplicity's sake, reserve currency tokens need not be utilized. Additionally, a predetermined number of insurance tokens 150 are distributed to each player at the beginning of the game. In some embodiments, for example, each player can receive one insurance token 150 at the start of the game, which can later be turned into the community bank area in lieu of receiving a penalty, e.g., rolling “craps.” Like the reserve currency tokens, insurance tokens cannot be exchanged for endgame tokens or action cards. Furthermore, according to the disclosed embodiments, a player can have, at most, two insurance tokens in his or her possession at any time during the game.

Those of skill in the ordinary skill in the art will also recognize that the number of currency tokens, reserve currency tokens, and insurance tokens distributed to each player at the beginning of the game can be increased or decreased accordingly. For example, in some embodiments, each player can receive one currency token, one reserve currency token, and one insurance token at the beginning of the game. In other embodiments, for example, no reserve currency tokens are used. Other combinations and permutations are possible and fully within the scope of the disclosed embodiments.

According to another aspect of the embodiments disclosed herein, zero-sum game 100 can also include a pair of random number generators 130. As shown in FIG. 1, random number generators 130 can comprise a pair of dice, with the first dice having a first color (e.g., red) and the second dice having a second color (e.g., green). During a turn, the active player can roll the pair of dice and, consequently, take one or more actions based on the outcome of the roll. For example, if the rolled number of the red dice is higher than the rolled number of the green dice, the player is required to surrender a currency token (if he or she possesses a currency token) to the community bank area and, subsequently, the player's turn ends. If the rolled number of the green dice is higher than the rolled number of the red dice, then the player may either exchange a currency token for an endgame token or, if the player has no currency tokens, the player may withdraw a currency token from the community bank area. Subsequently, the player receives another roll. Alternatively, the player can “buy” an action card by turning in a currency token into the community bank area and receiving an action card. Subsequently, the player's turn comes to an end. Notably, an action card cannot be played immediately after being bought.

Additionally, in most embodiments, if the rolled number of the red dice is equal to the rolled number of the green dice, hereinafter referred to as a “double roll,” the player shall take one or more actions based on the rolled number. For example, in most embodiments, if the player rolls “double ones” or “double sixes,” also referred to as “craps,” the player must surrender to the community bank a total of two currency tokens, which can include one or both of the currency tokens in the player's reserve. In the alternative, the player can choose, at his or her option, to surrender one insurance token to the community bank area in lieu of giving up two currency tokens. As another alternative, an active player may play the Double-back action card, if he or she possesses one, to negate the craps roll. In addition, in most embodiments, if the player rolling “craps” has one or more endgame tokens, but does not have any currency tokens or insurance tokens, the player must surrender an endgame token to the community bank area.

Furthermore, in some embodiments, double rolls can indicate different actions based on the number of players in the game. For example, in a two-player game, a double roll of either “double threes,” “double fours,” or “double fives” indicates a “Good Double,” and results in the player receiving a currency token and an action card from the community bank area, as well as receiving an option to purchase an action card or roll again. In other embodiments, a “Good Double” roll can yield only a currency token. Additionally, in some embodiments, consecutive “Good Double” rolls can yield additional benefits. For example, if a player achieves two “Good Doubles” in a row, the player can receive a free action card, i.e., the player does not have to turn in a currency token to receive an action card. In the alternative, the player, at his or her option, can choose to take an action card from an opponent player. However, the opponent player, at his or her option, may surrender an insurance token to prevent the active player from taking the action card. In other embodiments, if a player receives three “Good Doubles” in a row, the player can also receive a free endgame token from the community bank area.

Additionally, in a two-player game, a double roll of “double twos” indicates a “Super Double,” and results in the player receiving a currency token from the community bank area, as well as taking an endgame token from the player's opponent. Similarly, in a three-player game, a double roll of “double threes” indicates a “Super Double,” and results in the player receiving a currency token from the community bank area, as well as taking an endgame token from an opponent of the player's choosing. Likewise, in a four-player game, a double roll of “double fours” indicates a “Super Double.” In a game with five or more players, a double roll of “double fives” indicates a “Super Double.” After receiving the currency token and taking one endgame token from an opponent, the player can roll again.

A summary of roll actions is provided in Table 1 (below).

| | | | | |
|---|---|---|---|---|
| Double | | | | |
| Roll | Two Players | Three Players | Four Players | 5+ Players |

| | |
|---|---|
| 1's or | “Craps” - Player loses 2 currency tokens or 1 insurance token to |
| 6's | community bank area; player can negate craps by playing |
| | a Double-back action card. |

| 2's | “Super Double” - | “Good Double” - Player receives 1 currency | |
|---|---|---|---|
| | Player receives 1 | token and 1 action card from community bank | |
| | currency token from | area and takes another turn; has option to | |
| | community bank | buy an action card instead of rolling. | |
| | area and takes 1 | “3X Good Double” - 3 “Good Doubles” in a | |
| | endgame token from | row results in player receiving 1 endgame | |
| | opponent; rolls | token from community bank area. | |
| | again. | | |
| 3's | Good Double | Super Double | Good Double |

| | | | |
|---|---|---|---|
| 4's | Good Double | Super Double | Good Double |

| | | |
|---|---|---|
| 5's | Good Double | Super Double |

In addition to the above, when there is only one endgame token left in the community bank area, any active player who receives a “good double” may also cause the “leading” player (e.g., the player with the most endgame tokens) to surrender one endgame token to the community bank area. However, if the “leading” player has an insurance token, he or she can defend again this action by instead placing the insurance token in the community bank area.

It is also worth noting that in the embodiments described herein, random number generators 130 comprise a traditional pair of six-sided dice. In other embodiments, however, random number generators 130 can also comprise spinning wheels, non-traditional multi-sided dice, or programmatic instructions stored in the memory of an electronic device which, when executed, cause a processor of the electronic device to generate one or more random numbers.

Referring again to FIG. 1, in most embodiments, zero-sum game 100 also includes a non-standard deck of twenty-four (24) action cards 110, comprising eight (8) different types of action cards. These are comprised of four (4) Ace cards 111, four (4) Queen cards 112, four (4) Spider cards 113, four (4) Double-back cards 114, two (2) Money cards 115, two (2) King cards 116, two (2) Jewel cards 117 and two (2) Blank cards 118. Action cards 110 can be placed in the community bank area, face down, so as not to disclose their identity, and are not distributed to the players at the beginning of the game. Instead, a player may, at his or her option, exchange a currency token for an action card 110 either at the start of a player's turn or after receiving a “good roll,” for example, where the rolled number of the green dice is greater than the rolled number of the red dice. Each action card 110 signifies an action that a player can take during the course of playing the zero-sum game 100, as shown in Table 2 (below).

| Action Card | |
|---|---|
| (Total # in Deck) | Description of Action/Option to Play |
| Ace (4) | Player receives another turn; can only be played during player's turn, but |
| | not immediately after the card is acquired. |
| Queen (4) | Player can select another player that will lose his or her turn; can be |
| | played out of turn. |
| Spider (4) | Player can generate a new first random number, e.g., re-roll the red dice; |
| | can only be played during player's turn. |
| Double-back (4) | Player can negate a “craps” roll (double ones or sixes); can only be |
| | played during player's turn. |
| Money (2) | Player can take a currency token from either the community bank area or |
| | another player and receives another turn; can only be played during |
| | player's turn, but not immediately after the card is acquired. |
| King (2) | Player can receive an insurance token; can only be played during player's |
| | turn, but not immediately after the card is acquired. It should also be |
| | noted that a player can have a maximum of two insurance tokens at any |
| | time during the game. |
| Jewel (2) | Player can take an endgame token from another player; can only be |
| | played during player's turn, but not immediately after the card is |
| | acquired. |
| Blank (2) | No play or action; must be discarded during a subsequent turn causing a |
| | “lost turn” for the discarding player. |

In most embodiments disclosed herein, with the exception of the Queen action card, action cards can only be played during a player's turn. The Queen action card, however, can be played by a card-holding “inactive” player during another player's turn in order to make the active player lose his or her turn. In most embodiments described herein, a player may hold a maximum of two action cards in his or her possession at any time during the game.

### Example Embodiments of Starting Configurations

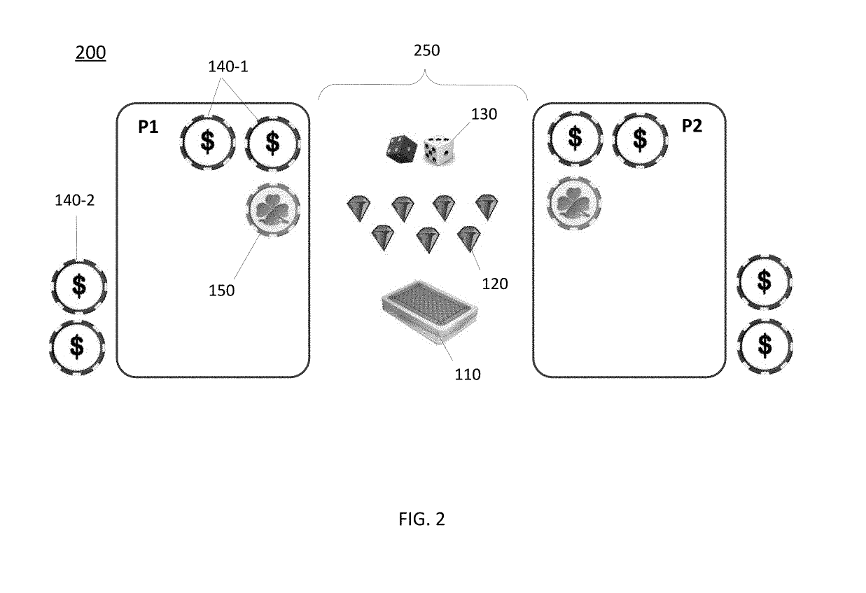

FIGS. 2-4 are pictorial diagrams depicting, starting arrangements for example embodiments of a zero-sum game where there are a various number of players.

FIG. 2, for example, depicts a starting arrangement 200 for an example embodiment of a zero-sum game where there are two players. At the beginning of the game, as shown at the left of FIG. 2, Player P1 receives two (2) currency tokens 140-1, one (1) insurance token 150, and two (2) currency tokens 140-2 held in reserve. As can be seen at the right of FIG. 2, Player P2 also receives the same distribution of tokens. Located in between Players P1 and P2 is a community bank area 250, which holds the random number generators 130, seven (7) endgame tokens 120, and a non-standard deck of twenty-four (24) action cards 110, with the cards placed face down so as not to reveal their identity.

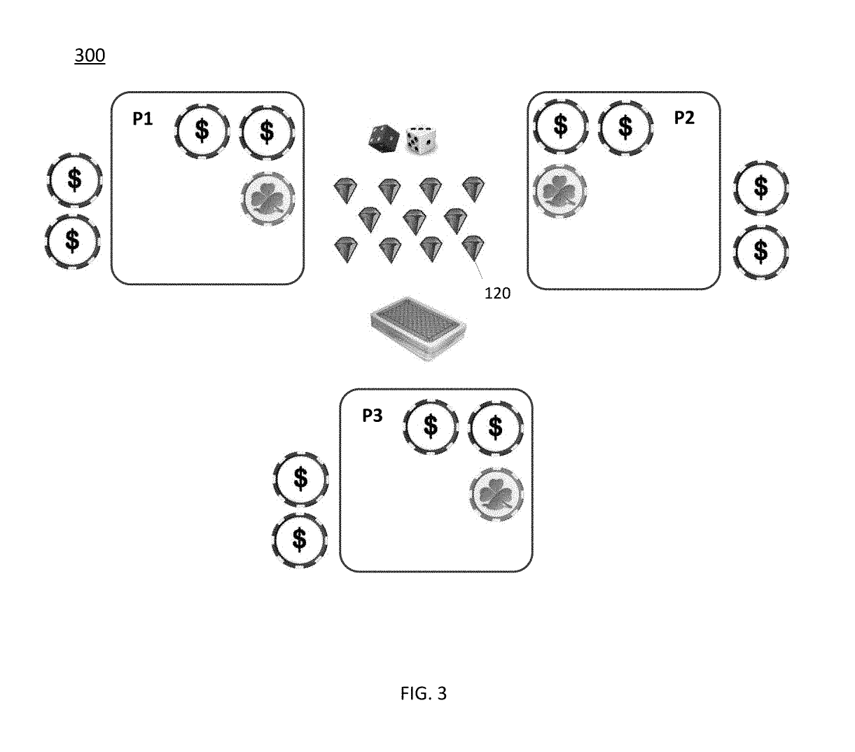

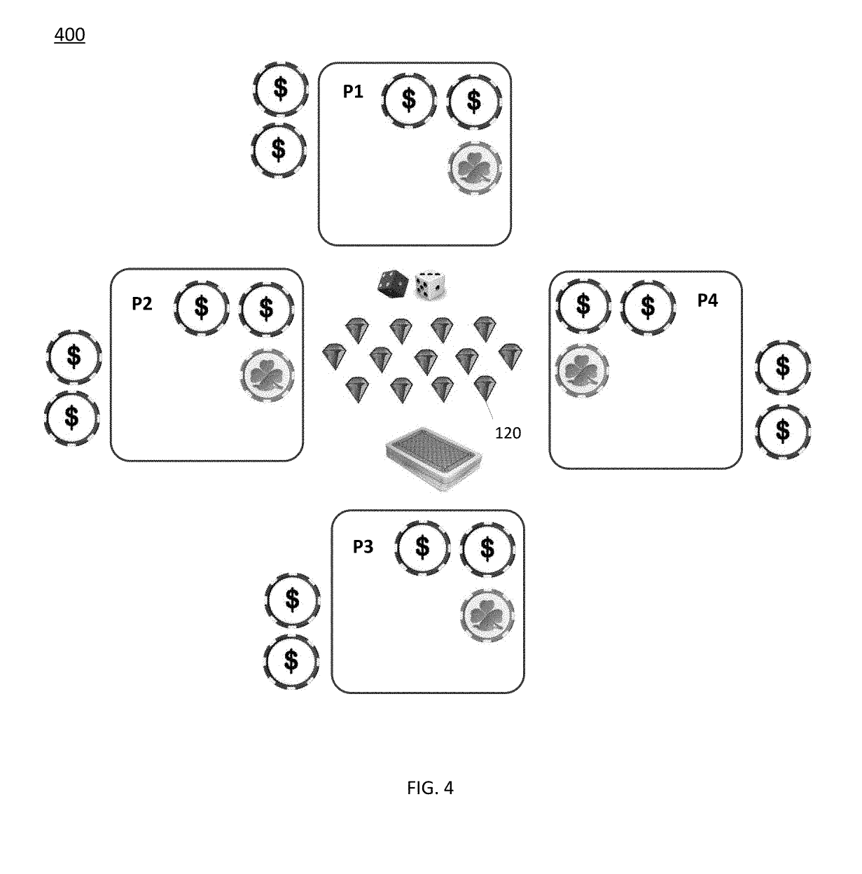

FIG. 3 shows a starting arrangement 300 for an example embodiment of a zero-sum game where there are three players (P1, P2, P3). As can be seen in FIG. 3, the starting arrangement is similar to that of FIG. 2, with the exception that there are eleven (11) endgame tokens 120 placed in the community bank area 250 at the beginning of the game. Likewise, FIG. 4 shows a starting arrangement 400 for an example embodiment of a zero-sum game where there are four players (P1, P2, P3, P4), including thirteen (13) endgame tokens 120 in the community bank area 250 at the beginning of the game. Those of ordinary skill in the art will recognize that games with five or more players will have similar starting arrangements, except the community bank area 250 will have fifteen (15) endgame tokens 120 available at the beginning of the game. In addition, as described earlier, in some alternative embodiments, reserve currency tokens are not utilized. In most embodiments, as the game proceeds, each player takes a turn in sequence, with the order of the sequence proceeding either in a clockwise manner (as shown in FIG. 3) or in a counterclockwise manner (as shown in FIG. 4).

### Example Turn Actions in a Zero-Sum Game

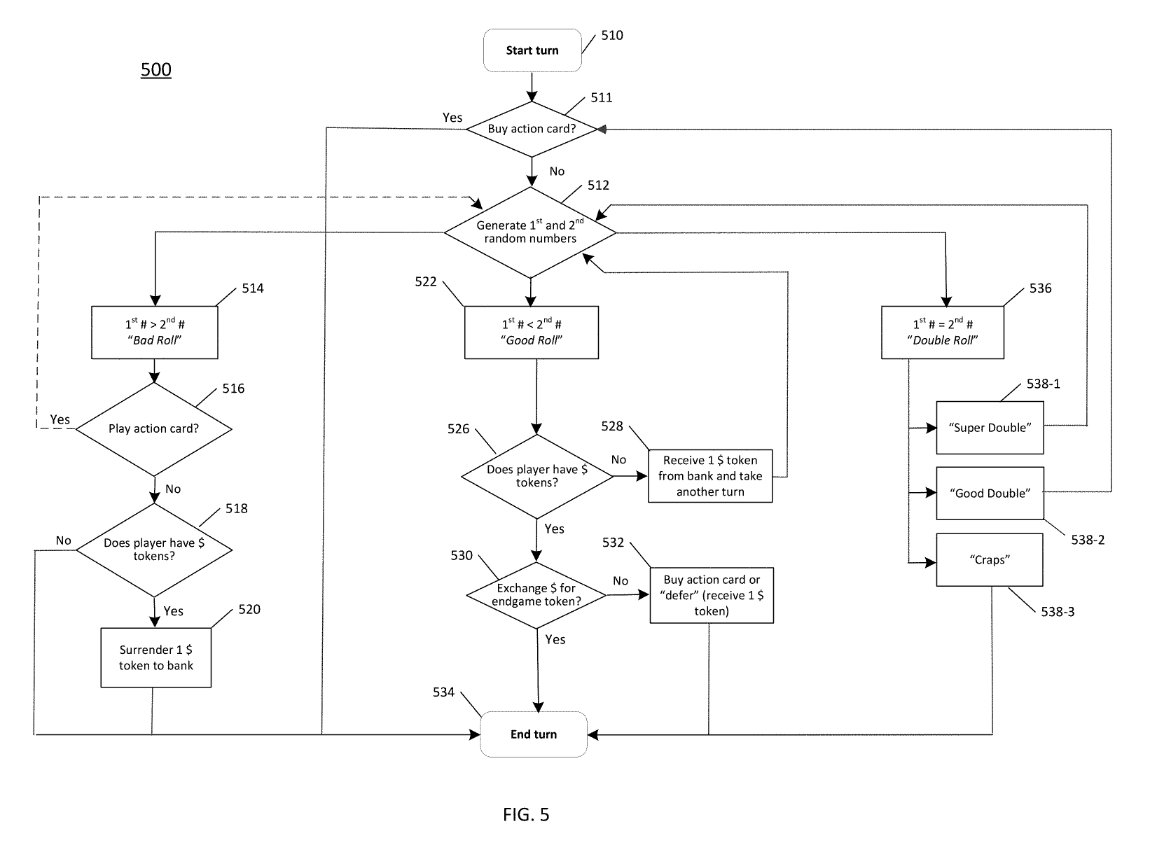

FIG. 5 is a flowchart diagram showing example turn actions 500 for one embodiment of a zero-sum game. As described earlier, at the beginning of the game, a predetermined number of currency tokens, reserve currency tokens and insurance tokens can be distributed to each player in the manner described with respect to FIGS. 2-4. Likewise, a predetermined and finite number of endgame tokens, a pair of random number generators, and a non-standard deck of twenty-four (24) action cards (face down) can be placed in the community bank area, preferably in a location that is both central to and equally convenient to each player. To determine which player goes first, one or both random number generators can be utilized, e.g., by selecting the player with the highest roll. Additionally, if there are more than two players, the players can mutually decide upon whether the sequence of turns will proceed in a clockwise or counterclockwise direction.

Turning to FIG. 5, the player taking a turn, hereinafter referred to as the active player, starts his or her turn at Step 510. At Step 511, the active player has an option to buy an action card. If the active player chooses to do so, he or she turns in one currency chip to the community bank area and receives, in exchange, one action card. When drawing an action card, the card itself is face down and the active player does not know what action card he or she is receiving. Upon receiving the card, the active player may privately view the card while making sure not to reveal the identity of the action card to his or her opponents. It is important to note that, according to most embodiments disclosed herein, the active player cannot play an action card in the same turn in which the action card is acquired. Subsequently, the player's turn ends.

If the active player decides not to buy an action card at Step 511, then the active player instead utilizes the first and second random number generators to generate, respectively, a first random number and a second random number, as shown at Step 512. In some embodiments, for example, Step 512 can comprise rolling a pair of dice, wherein the first dice is red and the second dice is green.

### Example Actions Relating to a Bad Roll

If the first random number is greater than the second random number, as shown at Step 514, the active player has received a “bad roll.” For example, in some embodiments, a “bad roll” can be where the rolled number of the red dice is greater than the rolled number of the green dice. At Step 516, after having received a “bad roll,” the active player has the option to play an action card, if appropriate. For example, if the active player is holding a Spider action card acquired during a previous turn, the active player may play the card by turning it into the community bank area. As previously described in Table 2, the Spider action card allows the active player to return to Step 512 (as indicated by the dashed line), and re-roll the first random number generator, e.g., the red dice. (Similarly, if the active player is holding a Jewel action card acquired from a previous turn, the active player may use it to “steal” an endgame token from an opponent. However, if the opposing player possesses an insurance token, he or she may turn it into the community bank to negate the Jewel action card.)

If the active player does not have a playable action card, then at Step 518, the active player next determines if he or she has any currency tokens. If the active player does not have any currency tokens, the active player's turn ends at Step 534. If the active player has one or more currency tokens, not including reserve currency tokens (if reserve currency tokens are being utilized), then at Step 520, the active player surrenders a currency token to the community bank area before his or her turn ends at Step 534.

### Example Actions Relating to a Good Roll

Referring back to FIG. 5, as shown at Step 522, if the first random number is less than the second random number, the active player has received a “good roll.” In some embodiments, an example of a “good roll” can be where the rolled number of the red dice is smaller than the rolled number of the green dice. At Step 526, the active player determines if he or she has any currency tokens. If the active player does not have any currency tokens, then at Step 528, the active player receives one currency token from the community bank area and returns to Step 512, thus receiving another turn. If, however, the active player has one or more currency tokens, not including reserve currency tokens (if reserve currency tokens are being utilized), then at Step 530, the active player has an opportunity to buy an endgame token (e.g., a jewel) by turning one currency token into the community bank area. If the active player decides to buy the endgame token, the active player's turn ends at Step 534.

In the alternative, as shown at Step 532, an active player who has received a “good roll” and possesses one or more currency tokens (not including reserve currency tokens), may choose to either buy an action card or “defer the turn,” instead of purchasing an endgame token. If the active player decides to buy an action card, he or she turns one currency token into the community bank area, receives the action card, and the active player's turn ends at Step 534. As mentioned earlier, a player may hold a maximum of two action cards in his or her possession at any time during the game. Similarly, if the active player decides to “defer” the turn, he or she may receive one currency token from the community bank area and the active player's turn ends at Step 534. In most embodiments, the “defer” option is only available when there is one jewel left in the community bank area. Additionally, in some embodiments, the “defer” option may only be used once by each player during one “round” of turns. The “defer” option may be preferable when there is one endgame token left in the community bank area, and the active player will lose the game if he or she buys the endgame token because an opponent already possesses more endgame tokens. Similarly, if an active player is behind an opponent by three or more endgame tokens, the defer rule offers a strategic way to catch up to the opponent. For example, the active player may acquire an action card that allows him or her to take an endgame token from an opponent.

### Example Actions Relating to a Double-Roll

Referring still to FIG. 5, as shown at Step 536, if the first random number is equal to the second random number, the active player has received a “double roll,” in accordance with the embodiments disclosed above with respect to Table 1. For example, if the active player has received a “Super Double” 538-1 (e.g., in a three-player game where the active player has rolled “double threes”), then the active player receives one currency token from the community bank area and also takes one endgame token away from an opponent of his or her choosing. Subsequently, the active player returns to Step 512 and can “roll” again. As another example, if the active player has received a “Good Double” 538-2 (e.g., in a three-player game where the active player has rolled either “double two,” “double fours,” or “double fives”), then the active player receives one currency token and one action card from the community bank area and begins another turn at Step 511. If the active player has received “craps” 538-3, i.e., where the active player has rolled either “double ones” or “double sixes,” then the active player loses either two currency tokens or one insurance token to the community bank area, and the active player's turn ends at Step 534. As described earlier, a player can negate a “craps” roll by playing a Double-back action card in his or her possession.

### Example Actions Relating to Determining Game Winner and Overtime

As described above, the zero-sum game ends when the final endgame token is removed from the community bank area. The player with the most endgame tokens is determined to be the winner of the game. In games where there are three or more players, a “tie” is possible if two or more players have both the same number of endgame tokens and the most endgame tokens. In some embodiments of the zero-sum game, an “overtime” game can be played where three endgame tokens are placed back into the community bank area and the first player to acquire two of the endgame tokens is the winner of the “overtime” game.

According to another aspect of the embodiments disclosed herein, the winner of the game can receive all of the currency tokens and the insurance tokens in the community bank area. The winner can calculate a point total by valuing each currency token as “one point,” and each insurance token as “two points.” In this manner, a series of games (e.g., three, four, five, etc.) can be played, and the ultimate winner can be determined by calculating the player with the highest “point total” at the end of the series of games. Alternatively, in lieu of calculating point totals, players can simply count each win as “one point,” and players can play a “best of three,” “best of five,” or “best of seven” series.

While the embodiments disclosed herein are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method of playing a zero-sum game for determining a winner from a predetermined number of players, the method comprising:
providing a predetermined number of endgame tokens, a first random number generator, a second random number generator, a plurality of currency tokens, a plurality of insurance tokens, and a non-standard deck of action cards;
distributing a predetermined number of currency tokens and insurance tokens to each player;
placing the predetermined number of endgame tokens in a community bank area;
if at least one endgame token is in the community bank area, designating a player as an active player and executing, by the active player, a turn comprising at least one of a plurality of turn actions including:
playing an action card and ending the turn;
generating a first number by the first random number generator and a second number by the second random number generator;
if the first number is greater than the second number, surrendering a currency token, if the active player possesses one or more currency tokens, and ending the turn;
if the second number is greater than the first number, exchanging a currency token for either one endgame token or one action card and ending the turn or, if the active player possesses no currency tokens, receiving a currency token and another turn;
if the first number is equal to the second number, executing one of a plurality of double-roll actions; and
if no endgame token is in the community bank area, ending the game and determining the winner.

2. The method of claim 1, wherein the first random number generator is a first six-sided dice of a first color, wherein the second random number generator is a second six-sided dice of a second color, and wherein the first color is different from the second color.

3. The method of claim 1, wherein distributing a predetermined number of currency tokens and insurance tokens to each player comprises receiving, by each player, receiving one insurance token and four currency tokens, wherein two currency tokens are designated as reserve currency tokens.

4. The method of claim 1, wherein the plurality of double-roll actions comprises surrendering to the community bank area either two currency tokens or one insurance token if the first number and the second number are either both ones or both sixes.

5. The method of claim 4, wherein the plurality of double-roll actions further comprises receiving from the community bank area one currency token and one action card if:
the predetermined number of players equals two players, and the first number and the second number are either both threes, both fours, or both fives;
the predetermined number of players equals three players, and the first number and the second number are either both twos, both fours, or both fives;
the predetermined number of players equals four players, and the first number and the second number are either both twos, both threes, or both fives; or
the predetermined number of players equals five or more players, and the first number and the second number are either both twos, both threes, or both fours.

6. The method of claim 5, wherein the plurality of double-roll actions further comprises receiving from the community bank area one currency token and receiving one endgame token from a player's opponent if:
the predetermined number of players equals two players, and the first number and the second number are either both twos;
the predetermined number of players equals three players, and the first number and the second number are either both threes;
the predetermined number of players equals four players, and the first number and the second number are either both fours; or
the predetermined number of players equals five or more players, and the first number and the second number are either both fives.

7. The method of claim 1, wherein playing an action card further comprises:
if the action card is an Ace action card, receiving another turn;
if the action card is a Queen action card, causing a player's opponent to lose a turn;
if the action card is a Spider action card, permitting the active player to generate a new first number using the first random number generator;
if the action card is a Double-back action card, negating a double roll if the first number and the second number are either both ones or both sixes;
if the action card is a Money action card, receiving a currency token from either the community bank area or a player's opponent, and receiving another turn;
if the action card is a King action card, receiving an insurance token from the community bank area;
if the action card is a Jewel action card, selecting a player's opponent and receiving an endgame token from the player's opponent; or
if the action card is a Blank action card, discarding the Blank action card in a subsequent turn and ending the turn.

8. The method of claim 4, further comprising surrendering, by the active player, one insurance token to the community bank area to negate a double roll action, wherein the first number and the second number are either both ones or both sixes.

9. The method of claim 7, wherein playing an action card further comprises surrendering, by the player's opponent, an insurance token to the community bank area instead of an endgame token to the active player, if the action card is a Jewel action card.

10. The method of claim 1, wherein determining the winner comprises identifying a player with a majority of endgame tokens.
